(19) United States
(12) Patent Application Publication
(10) Pub. No.: US 2013/0163717 A1
(43) Pub. Date: Jun. 27, 2013

(54) IMAGING APPARATUS

(71) Applicant: Kentaro Nagai, Yokohama-shi (JP)

(72) Inventor: Kentaro Nagai, Yokohama-shi (JP)

(73) Assignee: CANON KABUSHIKI KAISHA, Tokyo (JP)

(21) Appl. No.: 13/821,301

(22) PCT Filed: Aug. 23, 2011
(86) PCT No.: PCT/JP2011/069368

§ 371 Date: Mar. 7, 2013

(30) Foreign Application Priority Data
Sep. 8, 2010 (JP) 2010-201065

(51) Int. Cl. G01N 23/20

(52) U.S. Cl. CPC G01N 23/20075
USPC 378/36

(57) ABSTRACT

An imaging apparatus includes a light source unit; a diffraction grating diffracting light from the light source unit; and a detector detecting light from the diffraction grating, wherein the light source unit includes first light-emitting parts emitting light forming a first interference pattern by being diffracted at the diffraction grating, and second light-emitting parts emitting light forming a second interference pattern by being diffracted at the diffraction grating, wherein the first and the second light-emitting parts are disposed so that at least part of the first and second interference pattern overlap and the positions of light regions in the first interference pattern differ from the positions of light regions in the second interference pattern, and wherein a combined pattern is formed by the first interference pattern and the second interference pattern.

### TECHNICAL FIELD

The present invention relates to an imaging apparatus using Talbot interferometry.

### BACKGROUND ART

Talbot interferometry is a method of retrieving a phase image of a detected object using interference of light of various different wavelengths, including X-rays.

The outline of Talbot interferometry will be described below. As light emerged from a light source is transmitted through a detected object, the phase of the light is shifted. The light transmitted through the object is diffracted at a diffraction grating and forms an interference pattern. The interference pattern is detected by a detector, and the result of the detection is analyzed at a calculator to obtain differential phase images of the phase shift due to light passing through the object. By integrating the differential phase images, a phase image of the object can be obtained.

It is difficult to directly detect the interference pattern with an extremely small pitch. In such a case, a shielding grating that has a pitch that is slightly different from that of the interference pattern is disposed at the position where the interference pattern is formed to form a moire pattern by blocking part of the interference pattern with the shielding grating. Then, the moire pattern can be detected using a detector. In this way, differential images and a phase image of the object can be obtained in a manner similar to those obtained when the interference pattern is directly detected.

Highly coherence light should be used for Talbot interferometry. One way to increase the coherence is to reduce the size of the light source. In general, the light quantity of the light emitted from a small light source is small; therefore, the light quantity is insufficient for acquiring a phase image using a Talbot interferometer.

Accordingly, a method known as Talbot-Lau interferometry has been proposed. With Talbot-Lau interferometry, small light sources that emit highly coherent light are disposed at a predetermined pitch, and light regions are aligned with each other and dark regions are aligned with each other in the interference patterns formed by the light emitted from the light sources. In this way, the light quantity per unit time of the light incident on each pixel of the detector can be increased while maintaining high coherence of the light.

PTL 1 describes an imaging apparatus using Talbot-Lau interferometry by X-rays (hereinafter referred to as “X-ray Talbot-Lau interferometry”).

In the imaging apparatus describe in PTL 1, a grating having openings at a predetermined pitch, which is known as a source grating, is disposed immediately downstream of the X-ray source. In this way, Talbot-Lau interferometry is performed by imitating a state in which small X-ray sources are aligned at a predetermined pitch.

The small light sources and the openings in the source grating used in Talbot-Lau interferometry are parts from which light is emitted and thus are referred to as “light-emitting parts” in this document. To align the light regions with each other and the dark regions with each other in the interference patterns formed by light emitted from the light-emitting parts, the pitch P0 of the light-emitting parts satisfies the following expression:

P0=(R1/R2)×P2 (1)

where R1 represents the distance from the X-ray source to the diffraction grating, R2 represents the distance from the diffraction grating to the interference pattern, and P2 represents the pitch of the interference pattern. To perform Talbot-Lau interferometry, which detects a two-dimensional interference pattern or a two-dimensional moire pattern (hereinafter this method is referred to as “two-dimensional Talbot-Lau interferometry”), the light-emitting parts are disposed two-dimensionally at a pitch P0. By disposing the light-emitting parts in this way, the light regions align with each other and the dark regions align with each other in the interference patterns formed by the light emitted from the light-emitting parts.

### CITATION LIST

### Patent Literature

PTL 1 Japanese Patent Laid-Open No. 2009-240378

### SUMMARY OF INVENTION

### Technical Problem

As described above, the light used in Talbot-Lau interferometry should be highly coherent, and thus the light-emitting part must be small and arranged at a pitch satisfying Expression 1. Therefore, the size and pitch of the light-emitting parts are restricted to a certain extent.

This is a major problem in two-dimensional Talbot-Lau interferometry. In one-dimensional Talbot-Lau interferometry, light should be coherent in only one direction, and thus the size and pitch of the light-emitting parts are restricted only in this direction. In contrast, in two-dimensional Talbot-Lau interferometry, light should be coherent in two directions, which are orthogonal to each other, and thus the size and pitch of the light-emitting parts are restricted in these two directions. As a result, two-dimensional Talbot-Lau interferometry, when compared with one-dimensional Talbot-Lau interferometry, has problems in that the light quantity per unit time of the light incident on each pixel of the detector is small and the exposure time is long.

Accordingly, the imaging apparatus according to the present invention using two-dimensional Talbot-Lau interferometry increases the light quantity per unit time of the light incident on each pixel of the detector to shorten the exposure time.

### Solution to Problem

The image apparatus according to an aspect of the present invention includes an imaging apparatus including a light source unit; a diffraction grating configured to diffract light from the light source unit; and a detector configured to detect light from the diffraction grating, wherein the light source unit includes first light-emitting parts configured to emit light forming a first interference pattern by being diffracted at the diffraction grating, and second light-emitting parts configured to emit light forming a second interference pattern by being diffracted at the diffraction grating, wherein the first light-emitting parts and the second light-emitting parts are disposed so that at least part of the first interference pattern and at least part of the second interference pattern overlap and the positions of light regions in the first interference pattern differ from the positions of light regions in the second interference pattern, and wherein a combined pattern is formed by the first interference pattern and the second interference pattern.

Other aspects of the present invention will be described below in the embodiment.

### Advantageous Effects of Invention

The imaging apparatus according to the present invention using two-dimensional Talbot-Lau interferometry can increase the light quantity per unit time of the light incident on each pixel of the detector to shorten the exposure time.

### BRIEF DESCRIPTION OF DRAWINGS

FIG. 1 is a schematic view of an X-ray imaging apparatus according to an embodiment of the present invention.

FIG. 2 is a schematic view of a source grating of an embodiment of the present invention.

FIG. 3A illustrates an interference pattern of an embodiment of the present invention.

FIG. 3B illustrates an interference pattern and a combined pattern of an embodiment of the present invention.

FIG. 3C is a diagram illustrating the principle an interference pattern and a combined pattern of an embodiment of the present invention.

FIG. 4A is a schematic view of a diffraction grating of an embodiment of the present invention.

FIG. 4B is a schematic view of a diffraction grating of an embodiment of the present invention.

FIG. 5A is a schematic view of a shielding grating of an embodiment of the present invention.

FIG. 5B is a schematic view of a shielding grating of an embodiment of the present invention.

FIG. 6 is a schematic view of an X-ray imaging apparatus according to Example 1 of the present invention.

FIG. 7 is a schematic view of an X-ray imaging apparatus according to Comparative Example 1 in this document.

FIG. 8 is a schematic view of an X-ray imaging apparatus according to Comparative Example 2 example in this document.

FIG. 9A illustrates an object used in simulation according to Example 1 of the present invention and Comparative Examples 1 and 2 according to the related art.

FIG. 9B is simulated result of a phase image of the object acquired through image pickup of Example 1 according to the present invention.

FIG. 9C is simulated result of a phase image of the object acquired through image pickup of Comparative Example 1 according to the related art.

FIG. 9D is simulated result of a phase image of the object acquired through image pickup of Comparative Example 2 according to the related art.

FIG. 10 is a schematic view of a source grating of Comparative Example 1 in this document.

FIG. 11 is a diagram illustrating interference patterns in the related art.

FIG. 12 is a schematic view of a diffraction grating of Comparative Example 2 in this document.

FIG. 13 is a schematic view of a diffraction grating of Comparative Example 2 in this document.

### DESCRIPTION OF EMBODIMENT

An embodiment of the present invention will be described below with reference to the accompanying drawings. In the drawings, the same components are represented by the same reference numerals, and descriptions thereof are not repeated.

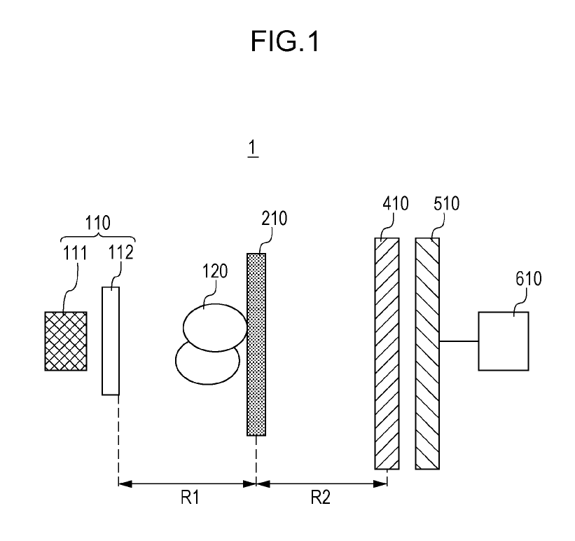

An imaging apparatus according to this embodiment uses two-dimensional X-ray Talbot-Lau interferometry. X-ray in this document is light having energy in the range of 2 to 100 keV. FIG. 1 is a schematic view of the configuration of the imaging apparatus according to this embodiment. The imaging apparatus 1, which is illustrated in FIG. 1, includes a light source unit 110 that emits an X-ray, a diffraction grating 210 that diffracts the X-ray, a shielding grating 410 that blocks part of the X-ray, a detector 510 that detects the X-ray, and a calculator 610 that performs calculation based on the result detected by the detector 510.

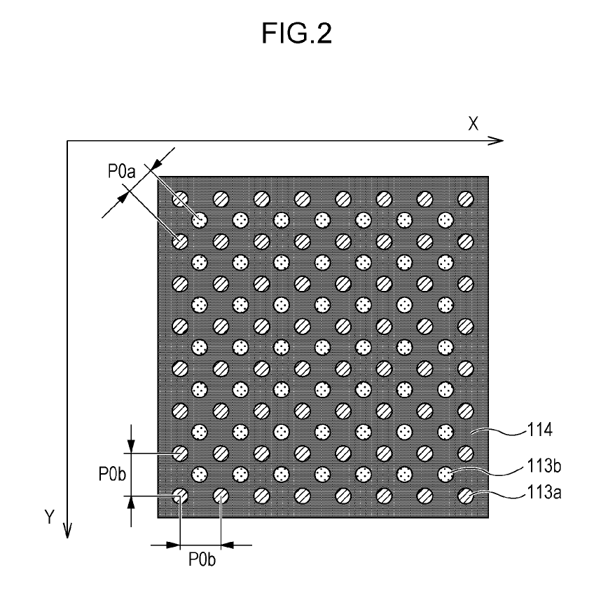

In the configuration according to this embodiment, which is illustrated in FIG. 1, the light source unit 110 includes an X-ray source 111 and a source grating 112; instead, the light source unit may include a plurality of small X-ray sources (micro-focus X-ray sources). In such a case, each X-ray source is considered as a light-emitting part. As illustrated in FIG. 2, the source grating 112 includes light-emitting parts 113 (113a and 113b) and light-blocking parts 114. The light-emitting parts 113 are arranged at a 45 degree angle with respect to the X and Y directions, and the pitch P0ₐ satisfies the following expression:

P0ₐ=(R1/R2)×(P2/√2) (2)

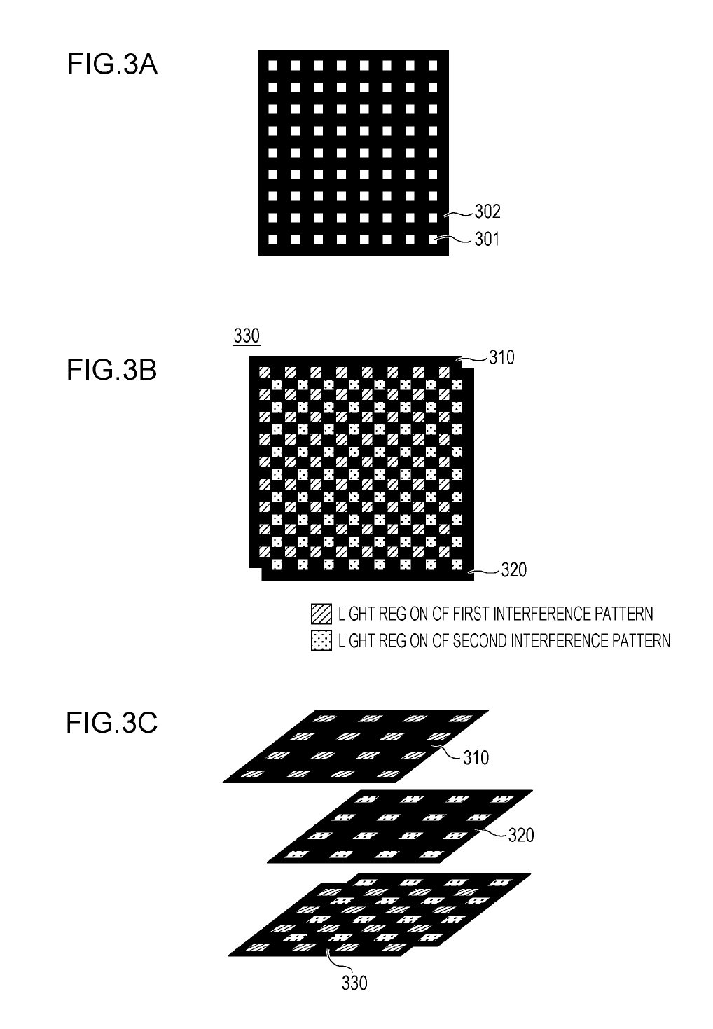

In this embodiment, the distance from the diffraction grating to the interference pattern is the distance from the diffraction grating to the shielding grating, and the pitch of the interference pattern is the pitch of the first or second interference pattern arranged on the shielding grating. The source grating 112 includes the first light-emitting parts 113a and the second light-emitting parts 113b, and the pitch P0_{b} of the first light-emitting parts 113a and the second light-emitting parts 113b satisfies Expression 1. The X-rays emitted from the first light-emitting parts 113a are diffracted at the diffraction grating 210 and form a first interference pattern 310, which is illustrated in FIG. 3A. Similarly, the X-rays emitted from the second light-emitting parts 113b are diffracted at the diffraction grating 210 and form a second interference pattern 320. When the source grating 112, which is illustrated in FIG. 2, is used, the first interference pattern 310 and the second interference pattern 320 overlap on the shielding grating 410, and the light regions of the first interference pattern 310 and the light regions of the second interference pattern 320 are projected on different areas, forming a pattern 330, which is illustrated in FIG. 3B. As illustrated in FIG. 3B, when at least part of the first interference pattern 310 and at least part of part of the second interference pattern 320 overlap, and the light regions of the first interference pattern 310 and the light regions of the second interference pattern 320 are projected on different areas, the pattern 330 is newly generated. This pattern 330 is referred to as “combined pattern 330” in this document. FIG. 3C illustrates the principle of the combined pattern in this embodiment. Actually, the first interference pattern 310 and the second interference pattern 320, which form the combined pattern 330, are projected on the same layer; however, the patterns are illustrated as separate layers for description. As illustrated in FIG. 3C, the combined pattern 330, which is a newly-formed pattern, is generated by the light regions of the first interference pattern 310 and the light regions of the second interference pattern 320 being projected on different areas.

Since the combined pattern 330 has periodicity in a two-dimensional direction (in both the X and Y directions), a two-dimensional moire pattern is generated by using a shielding grating that has periodicity in the same two-dimensional direction as the combined pattern 330. By detecting and analyzing the two-dimensional moire pattern, a two-dimensional differential phase image of the object 120 can be acquired. Even if the pitch P0ₐ of the light-emitting parts do not strictly satisfy Expression 2, the deviation from the pitch P0ₐ is considered as being within the error range so long as the combined pattern 330 has periodicity in two-dimensional directions. It is preferable, however, that the deviation from the pitch P0ₐ be small.

In this embodiment, a moire pattern is generated using a shielding grating; instead, two-dimensional Talbot interferometry may be performed by directly detecting the combined pattern 330. When two-dimensional Talbot interferometry is performed by directly detecting the combined pattern 330, the distance from the diffraction grating to the interference pattern is the distance from the diffraction grating to the detector, and the pitch of the interference pattern is the pitch of the first or second interference pattern arranged on the detector.

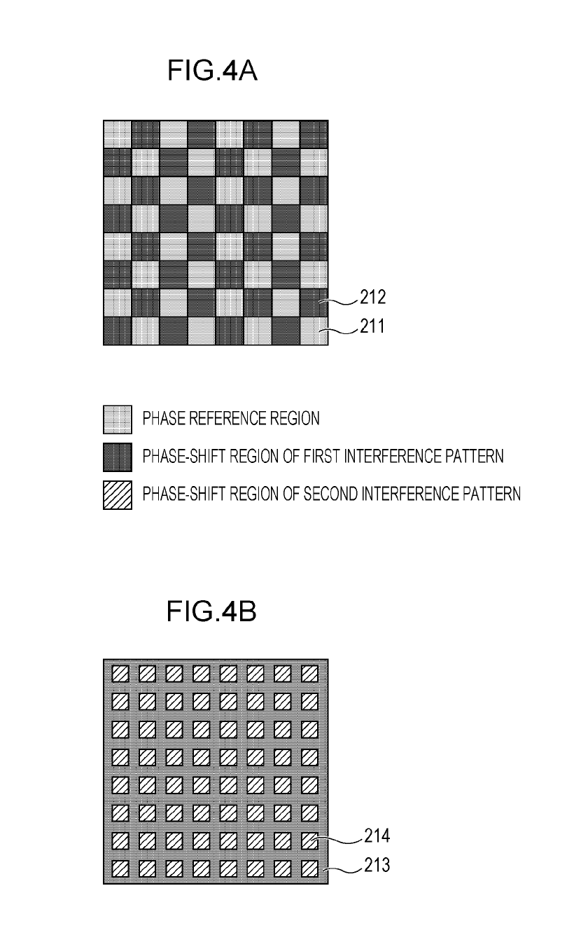

The diffraction grating 210 in this embodiment forms a grid-shaped interference pattern when the X-ray emitted from a light-emitting part is incident thereon without passing through the object 120. In a grid-shaped interference pattern of this embodiment, light regions 301 are surrounded by a dark region 302 and the light regions 301 do not contact each other, such as in the first interference pattern 310 illustrated in FIG. 3A. FIGS. 4A and 4B illustrate examples of diffraction gratings that may be used in this embodiment, i.e., diffraction gratings that form the interference pattern shown in FIG. 3A. The diffraction grating illustrated in FIG. 4A is a phase grating and includes phase reference regions 211 and first phase-shift regions 212, which are arranged in a checkerboard pattern. The phase of the X-rays transmitted through the first phase-shift regions 212 is shifted by it radian with respect to the phase of the X-rays transmitted through the phase reference regions 211, which is set as a reference. The diffraction grating illustrated in FIG. 4B is also a phase grating and includes phase reference regions 213 and second phase-shift regions 214, which are arranged in a grid pattern. The phase of the X-rays transmitted through the second phase-shift regions 214 is shifted by π/2 radians with respect to the phase of the X-rays transmitted through the phase reference regions 213, which is set as a reference.

In this embodiment, a diffraction grating that forms a grid-shaped interference pattern is used; however, other diffraction gratings may be used so long as they form an interference pattern in which each light region formed by light emitted from each of the light-emitting parts is isolated when the light is diffracted without passing through the object. The combined pattern is not limited to a checkerboard pattern so long as the light regions of the first interference pattern and the light regions of the second interference pattern are formed on different areas on the shielding grating and so long as there is periodicity in two directions X and Y orthogonal to each other.

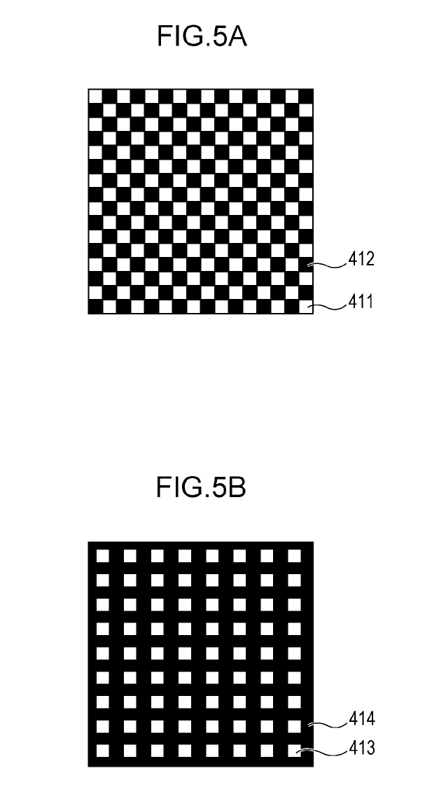

In this embodiment, it is desirable that a shielding grating 410, such as that illustrated in FIG. 5A, include X-ray transmissive regions 411 and X-ray shielding regions 412 arranged in a checkerboard pattern, in a manner similar to the combined pattern. A shielding grating in which X-ray transmissive regions 413 and X-ray shielding regions 414 are arranged in a grid pattern, as illustrated in FIG. 5B and similar to the first or second interference pattern, may also be used.

To detect the intensity of a moire pattern, a detector 510 in this embodiment includes a device (for example, a CCD) that can detect the intensity of a moire pattern caused by an X-ray.

The result detected by the detector 510 is sent to a calculator 610 for calculation to acquire information about the phase image of the object 120. The imaging apparatus according to this embodiment includes a calculator 610; the imaging apparatus, however, does not necessarily have to include a calculator. When the imaging apparatus does not include a calculator, a calculator is provided independently from the imaging apparatus and is connected to the detector.

In this embodiment, information about the phase image acquired by the calculator 610 is sent to an image display apparatus (not shown), where the phase image is displayed. In this embodiment, the image display apparatus is provided independently from the imaging apparatus; the image display apparatus may instead be integrated with the imaging apparatus. In this document, an integrated unit of the image display apparatus and the imaging apparatus is referred to as “image pickup system.”

In this embodiment, the object 120 is interposed between the light source unit and the diffraction grating; the object 120 may instead be interposed between the diffraction grating and the shielding grating.

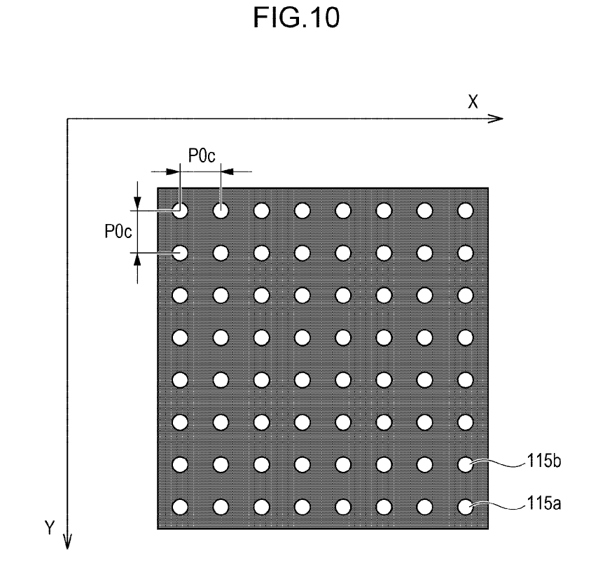

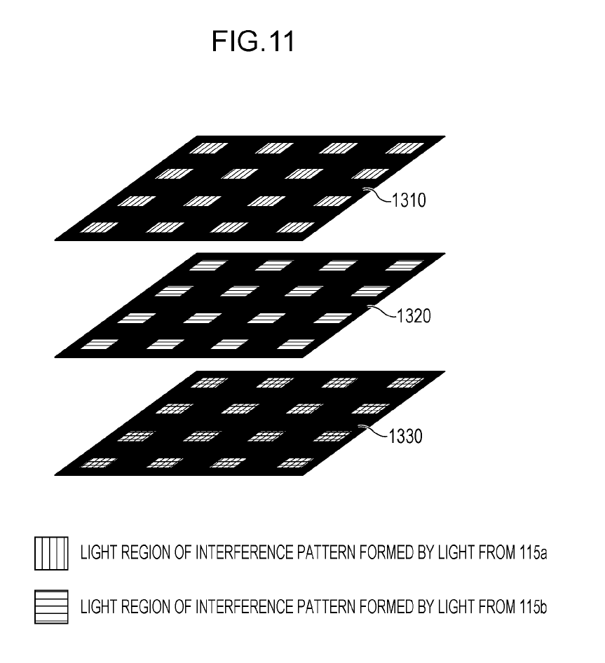

With known one-dimensional and two-dimensional Talbot-Lau interferometry, the light regions overlap each other and the dark regions overlap each other in the interference patterns formed by light from the light-emitting parts. Therefore, with two-dimensional Talbot-Lau interferometry, the light-emitting parts are arranged along two directions, which are orthogonal to each other, such that the pitch satisfies Expression 1. That is, the pattern on the source grating is the same as the interference pattern formed by diffracting the light emitted from a light-emitting part at a diffraction grating. For example, in the past, when a diffraction grating that forms a grid-shaped interference pattern similar to that illustrated in FIG. 3A of this embodiment, a source grating illustrated in FIG. 10 was used. The pitch P0_{c} of light-emitting parts 115 (115a, 115b, . . . ) satisfies Expression 1. Compared with the source grating used in this embodiment, the source grating illustrated in FIG. 10 includes only first light-emitting parts and does not include second light-emitting parts, and the light regions overlap with each other and the dark regions overlap with each other in the interference patterns formed by the light from the light-emitting parts. This will be described below with reference to FIG. 11. An interference pattern 1310 illustrated in FIG. 11 is formed by light emitted from light-emitting parts 115a; similarly, an interference pattern 1320 is formed by light emitted from light-emitting parts 115b. As a result of both of these interference patterns being formed on a shielding grating with the light regions of the interference patterns being projected on same areas, a pattern 1330, which is the same patterns as the patterns 1310 and 1320, is formed on the shielding grating. In the past, Talbot-Lau interferometry was carried out by overlapping the light regions with each other in the interference pattern formed by light emitted from all of the light-emitting parts in the source grating illustrated in FIG. 10.

The pitch P0_{c} of the light-emitting parts in a known source grating is represented as P0_{c}=(R1/R2)×P2, whereas the pitch P0ₐ of the light-emitting parts according to this embodiment is represented as P0ₐ=(R1/R2)×(P2/√2). Therefore, in comparison with Talbot-Lau interferometry according to the related art, the number of light-emitting parts per unit area with Talbot-Lau interferometry according to this embodiment is doubled, and if other conditions are the same, the light quantity per unit time of the light incident on each pixel of the detector is also doubled.

### Example 1

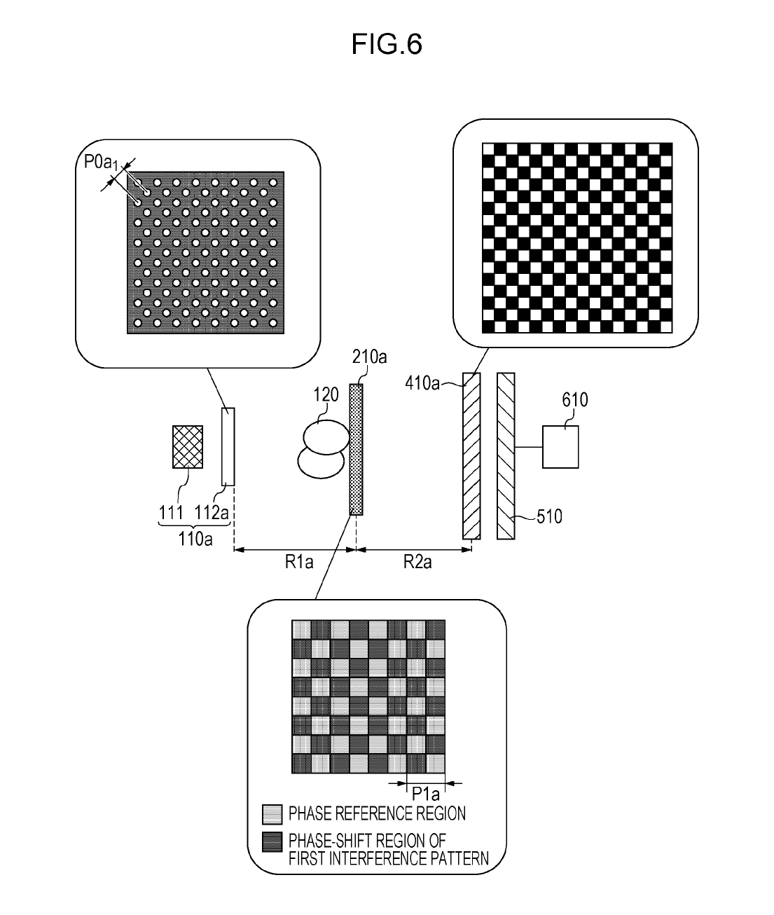

Example 1 of the embodiment will be described below with reference to FIG. 6. Example 1, which is illustrated in FIG. 6, included an imaging apparatus having the configuration illustrated in FIG. 1, a source grating illustrated in FIG. 2, and a diffraction grating illustrated in FIG. 4A. The pitch P1a of the diffraction grating was 8.0 μm. The X-ray source emitted diffusing X-ray of 17.5 keV. Since the distance R1a from the light source to the diffraction grating was 1.0 m and the distance R2 from the diffraction grating to the shielding grating was 12.73 cm, the magnification of the interference pattern due to the effect of spherical waves was 1.12 times. Thus, the pitch P2a of the interference pattern was 4.5 μm.

The pitch P0ₐ₁ of the light-emitting parts of the source grating was 1/0.1273×4.5/√2≅25.00 (μm). The aperture ratio of the source grating equaled:

(10/2)²×3.14/25.00²×100≅13%

where the diameter of each light-emitting part was 10 μm.

Detection and analysis of the moire pattern formed by the shielding grating illustrated in FIG. 5A were performed, and the process of acquiring a differential phase images was simulated.

### Comparative Example 1

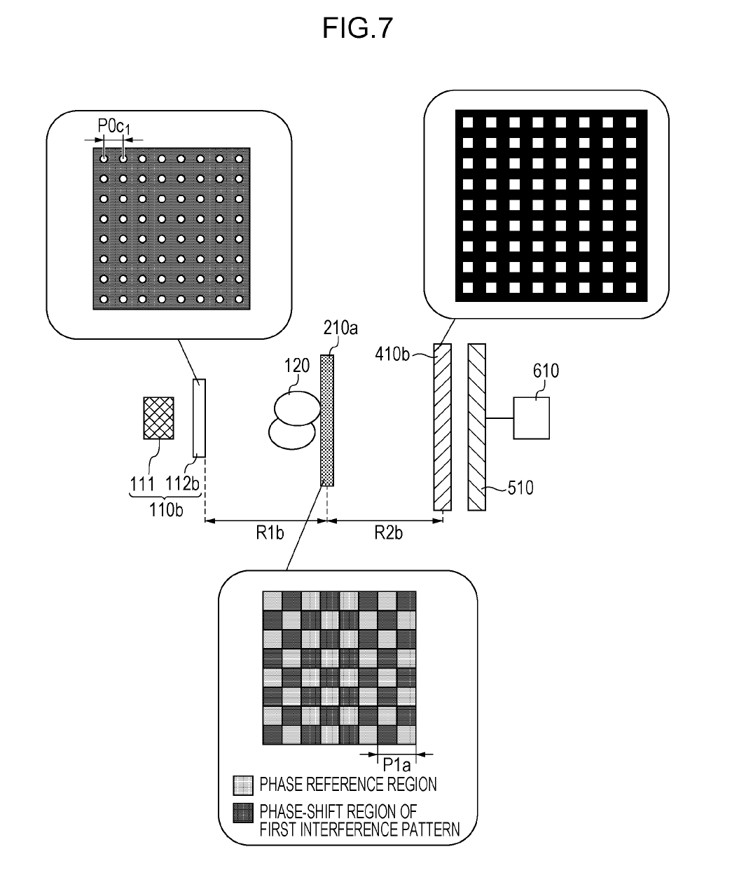

As Comparative Example 1, the aperture ratio of a known imaging apparatus using a diffraction grating that is the same as that according to Example 1 was calculated. As illustrated in FIG. 7, the configuration was the same as that according to Example 1, except that the source grating and the shielding grating differ. The same source grating as that illustrated in FIG. 10 and the same diffraction grating as that illustrated in FIG. 4A were used. Similar to Example 1, the pitch P1a of the diffraction grating was set to 8.0 μm, R1b was set to 1.0 m, R2b was set to 12.73 cm, and, as a result, the pitch P2b of the interference pattern was set 4.5 μm.

The calculated pitch P0_{c1} of the light-emitting parts of the source grating was 1/0.1273×4.5≅34.35 (μm). Similar to Example 1, the calculated aperture ratio of the source grating was:

(10/2)²×3.14/34.35²×100≅6.7%

where the diameter of each light-emitting part was 10 μm.

Detection and analysis of a moire pattern formed by the shielding grating illustrated in FIG. 5B were performed, and the process of acquiring a differential phase image was simulated.

### Comparative Example 2

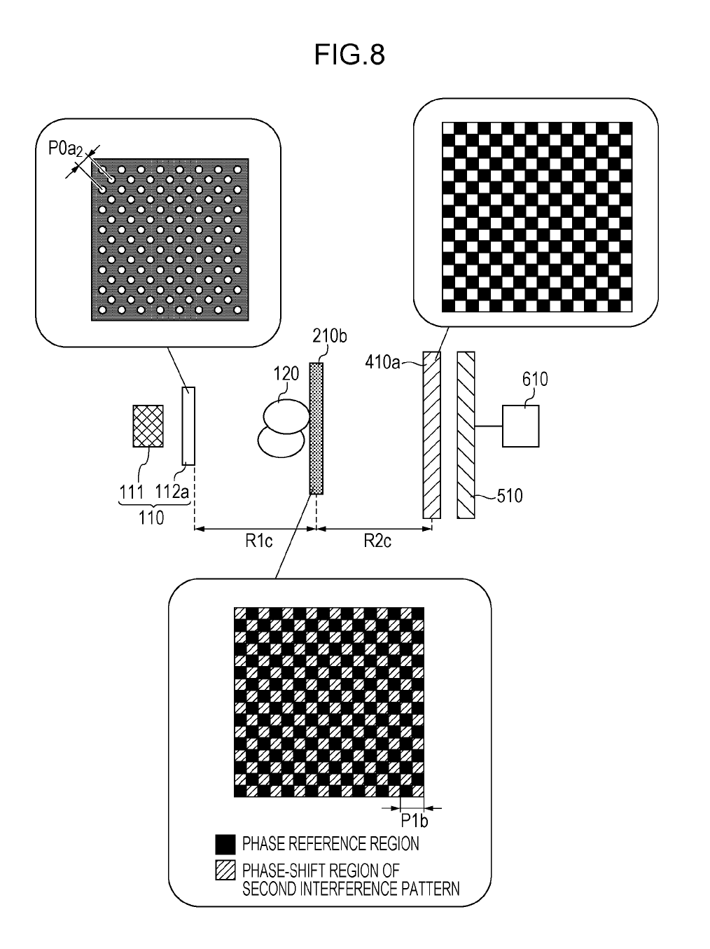

As Comparative Example 2, the aperture ratio of a known imaging apparatus using a source grating that is the same as that according to Example 1 was calculated. As illustrated in FIG. 8, the configuration was the same as that according to Example 1, except that the distance from the diffraction grating to the shielding grating differs.

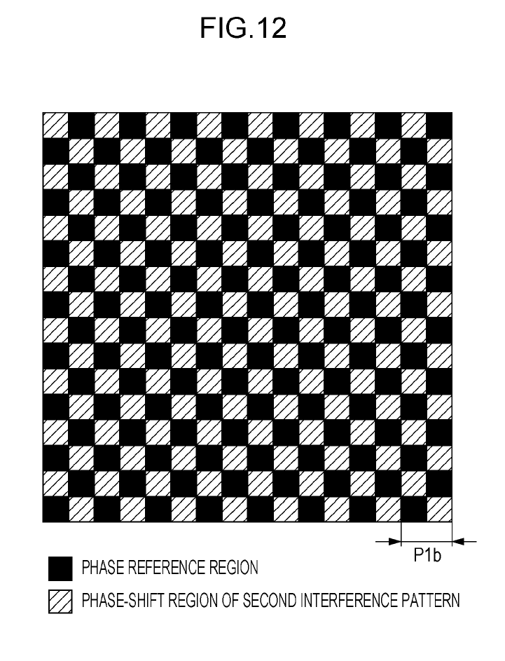

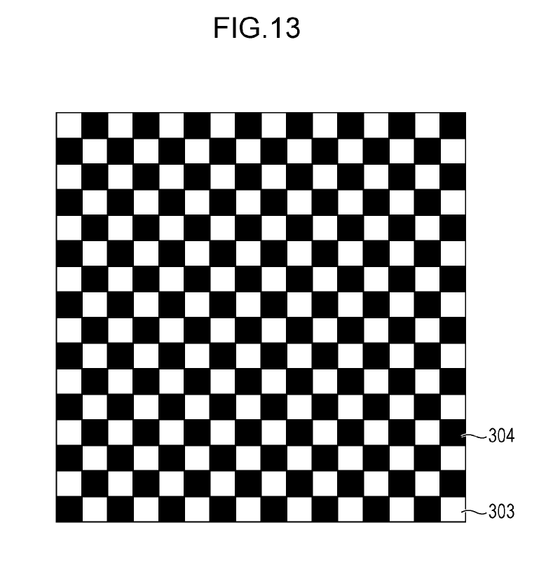

When the source grating that is the same as that of Example 1 is used, the diffraction grating used in the past was that illustrated in FIG. 13. In this diffraction grating, phase reference parts and second phase-shift parts were arranged in a checkerboard pattern, in a manner similar to Example 1. The phase of the X-rays transmitted through the second phase-shift regions was shifted by π/2 radians with respect to the phase of the X-rays transmitted through the phase reference regions, and the pitch P1b of the grating was 4.0 μm. By using this diffraction grating, light regions 303 and dark regions 304 in the interference pattern were arranged in a checkerboard pattern, as illustrated in FIG. 12.

Since R1c was set to 1.0 m and R2c was set to 29.16 cm, the magnification of the interference pattern was 1.29 times, and the pitch P2c of the interference pattern was 7.31 μm.

The calculated pitch POₐ₂ of the openings in the source grating was:

1/0.29×7.3125.0(μm).

Similar to Example 1, the calculated aperture ratio of the openings was:

(10/2)²×3.14/25.0²×100≅13%

where the diameter of each opening was 10 μm.

Since the interference pattern formed in this comparative example was the same as the combined pattern formed in Example 1, detection and analysis of a moire pattern formed by the shielding grating illustrated in FIG. 5A, which is the same as that in Example 1, were performed, and the process of acquiring a differential phase image was simulated. The aperture ratio in Example 1 is approximately twice the aperture ratio in Comparative Example 1. Since the configuration except for the source grating is the same, the light quantity per unit time of the light incident on each pixel of the detector in Example 1 is twice as that in Comparative Example 1.

The aperture ratio is the same for Example 1 and Comparative Example 2. However, the distance R2 in Comparative Example 2 was larger than that in Example 1. As a result, the size and the interference pattern magnification (P2/P1) of the imaging apparatus according to Comparative Example 2 increase, and the light quantity per unit time of the light incident on each pixel of the detector decreases in comparison with Example 1.

The table below lists the light quantity per unit time of the light incident on each pixel of the detector and the length of the apparatus, where these are respectively set to one in Comparative Example 1.

TABLE 1

| | Light quantity (per | |
|---|---|---|
| | unit time, per | Apparatus |
| | pixel in detector) | length |
| Comparative | 1 (reference) | 1 (reference) |
| Example 1 | | |
| (reference) | | |
| Comparative | 1.5 | 1.14 |
| Example 2 | | |
| Example 1 | 2 | 1 |

As listed above, the light quantity per unit time of the light incident on each pixel of the detector is great for Example 1 in comparison with Comparative Examples 1 and 2.

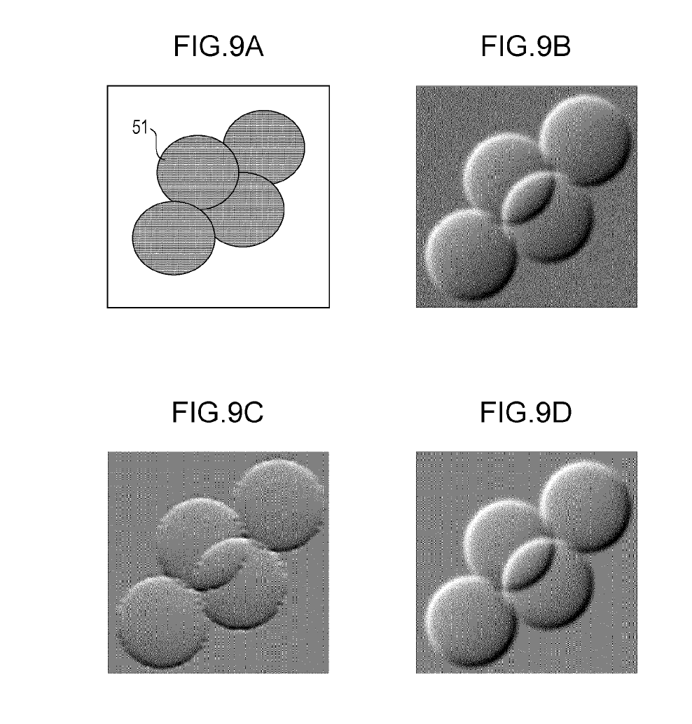

Since the simulations were performed without considering the exposure time, the obtained simulation results were differential phase images for when light quantity was sufficient under respective conditions, and the light quantity per unit time of the light incident on each pixel of the detector was not reflected. FIG. 9A is a side view of the object 120, which is illustrated in FIG. 1, from the light source unit and illustrates the object as four overlapping spheres 51. FIG. 9B is a differential phase image acquired through simulation according to Example 1. FIG. 9C is differential phase image acquired through simulation according to Comparative Example 1. FIG. 9D is differential phase image acquired through simulation according to Comparative Example 2. FIGS. 9A to 9D indicate that the quality of the differential phase image acquired in Example 1 is equal to or higher than that acquired in the related art.

As listed in Table 1, since the light quantity per unit time of the light incident on each pixel of the detector of Example 1 is greater than that of Comparative Examples 1 and 2, image pickup in Example 1 can be performed in a shorter amount of time than that in Comparative Examples 1 and 2. When image pickup is performed with the same amount of exposure time, a differential phase image with a lower level of noise can be acquired in Example 1 than the level of noise in Comparative Examples 1 and 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-201065, filed Sep. 8, 2010, which is hereby incorporated by reference herein in its entirety.

### INDUSTRIAL APPLICABILITY

The present invention can be applied to an imaging apparatus that detects an object by using a phase shift that occurs when light, which includes X-rays, is transmitted through the object.

### REFERENCE SIGNS LIST

1 imaging apparatus
110 light source unit
120 object
210 diffraction grating
410 shielding grating
510 detector
113a first light-emitting parts
113b second light-emitting parts
310 first interference pattern
320 second interference pattern
301 light regions of interference pattern

1. An imaging apparatus comprising:
a light source unit;
a diffraction grating configured to diffract light from the light source unit; and
a detector configured to detect light from the diffraction grating,
wherein the light source unit includes
first light-emitting parts configured to emit light forming a first interference pattern by being diffracted at the diffraction grating, and
second light-emitting parts configured to emit light forming a second interference pattern by being diffracted at the diffraction grating,
wherein the first light-emitting parts and the second light-emitting parts are disposed so that at least part of the first interference pattern and at least part of the second interference pattern overlap and the positions of light regions in the first interference pattern differ from the positions of light regions in the second interference pattern, and
wherein a combined pattern is formed by the first interference pattern and the second interference.

2. The imaging apparatus according to claim 1, wherein,
the first interference pattern and the second interference pattern are grid patterns, and the combined pattern is a checkerboard pattern.

3. The imaging apparatus according to claim 1, wherein,
the light source unit includes
a light source, and
a source grating having a plurality of openings, and
the openings are the first light-emitting parts and the second light-emitting part.

4. The imaging apparatus according to claim 1, wherein,
the light source unit includes a plurality of light sources, and
the light sources are the first light-emitting parts and the second light-emitting part.

5. The imaging apparatus according to claim 1, wherein pitch P0 of the light-emitting parts is represented as:
P0=(R1/R2)×(P2/√2)
where R1 represent the distance from one of the light-emitting parts to the diffraction grating, R2 represents the distance from the diffraction grating to the first or second interference pattern, and P2 represents the pitch of the first or second interference pattern.

6. The imaging apparatus according to claim 1, further comprising:
a shielding grating configured to transmit part of the light from the diffraction grating, wherein the combined pattern is formed on the shielding grating.

7. The imaging apparatus according to claim 1, wherein the combined pattern is formed on the detector.

8. The imaging apparatus according to claim 1, wherein the first interference pattern is the same as the second interference pattern.

9. The imaging apparatus according to claim 1, wherein the light source unit is an X-ray light source unit.

10. The imaging apparatus according to claim 1, further comprising:
a calculator,
wherein the calculator calculates based on a result obtained by the detector.

11. An imaging system comprising:
the imaging apparatus according to claim 10; and
an image display apparatus,
wherein the imaging apparatus and the image display apparatus are connected, and
wherein the image display apparatus displays an image based on a result of calculation by the calculator.
